(19) United States
(12) Patent Application Publication
(10) Pub. No.: US 2024/0189792 A1
(43) Pub. Date: Jun. 13, 2024

(54) MICROWAVE-ASSISTED CATALYSIS FOR HYDROGEN SULFIDE TREATMENT

(71) Applicant: Saudi Arabian Oil Company, Dhahran (SA)

(72) Inventors: Ghaith J. Nadhreen, Thuwal (SA); Abdulrahman B. Aljedaani, Thuwal (SA)

(21) Appl. No.: 18/080,262

(22) Filed: Dec. 13, 2022

(51) Int. Cl. B01J 8/10; B01J 8/08; C01B 3/04; C01B 17/04

(52) U.S. Cl. CPC B01J 8/10; B01J 8/085; C01B 3/04; C01B 17/0495

(57) ABSTRACT

A Traveling Wave Reactor (TWR) includes an inner microwave-transparent tube including an inlet and an outlet; an outer resonant tube surrounding a section of the microwave-transparent tube; a microwave source operable to provide microwave radiation to the resonant tube, wherein the microwave radiation creates a traveling microwave field in the resonant tube; and a tube rotator operable to rotate the microwave-transparent tube. A method for H₂S treatment includes introducing a gas comprising H₂S into a Traveling Wave Reactor (TWR), wherein the TWR includes a microwave source and a microwave-transparent tube including a catalyst bed; contacting the gas with the catalyst bed; and irradiating the catalyst bed with microwaves emitted by the microwave source, thereby activating a conversion of H₂S.

### FIELD

The disclosure relates to a Traveling Wave Reactor for microwave-assisted catalysis and a method for treating hydrogen sulfide.

### BACKGROUND

Superclaus plants for the treatment of hydrogen sulfide (H2S) use thermo-catalytic reactions that ultimately result in elemental sulfur and water vapor. This method requires high temperatures (above 1000° C.), generates a toxic SO₂ intermediate, has low conversion, and wastes potential hydrogen as water vapor. Thermo-catalytic methods utilize conventional heat transfer (conduction and convection) to induce the chemical reaction.

### SUMMARY

The disclosure relates to a Traveling Wave Reactor (TWR) and methods that utilize microwave-assisted catalysis (MAC) to treat hydrogen sulfide. Unlike thermo-catalytic methods, MAC uses microwave irradiation to induce a chemical reaction. The methods disclosed herein generate hydrogen gas as a value-added product, which can be utilized as a sustainable source of fuel. The method has several other advantages over the Superclaus method because it is a single-step reaction and has lower activation energy and operational temperatures, leading to more efficient reactions and higher conversion.

The disclosure provides a Traveling Wave Reactor (TWR), including an inner microwave-transparent tube including an inlet and an outlet; an outer resonant tube surrounding a section of the microwave-transparent tube; a microwave source operable to provide microwave radiation to the resonant tube, wherein the microwave radiation creates a traveling microwave field in the resonant tube; and a tube rotator operable to rotate the microwave-transparent tube.

In certain embodiments, the section of the microwave-transparent tube surrounded by the resonant tube includes a catalyst bed. In certain embodiments, the catalyst bed includes a metal-based catalyst. In certain embodiments, the catalyst bed includes a catalyst and a catalyst support. In certain embodiments, the catalyst support is alumina or a magnesium-based catalyst support.

In certain embodiments, the TWR further includes a microwave absorber at an end of the resonant tube.

In certain embodiments, the microwave source does not generate standing waves in the resonant tube. In certain embodiments, the microwave source provides microwaves at a frequency in a range of 500 MHz to 3000 MHz.

In certain embodiments, the tube rotator is operable to rotate the microwave-transparent tube about a longitudinal axis of the microwave-transparent tube.

The disclosure also provides a method for H₂S treatment including: introducing a gas comprising H₂S into a Traveling Wave Reactor (TWR), wherein the TWR includes a microwave source and a microwave-transparent tube including a catalyst bed; contacting the gas with the catalyst bed; and irradiating the catalyst bed with microwaves emitted by the microwave source, thereby activating a conversion of H₂S.

In certain embodiments, the irradiating activates a catalytic conversion of H₂S to hydrogen gas and elemental sulfur.

In certain embodiments, the method further includes rotating the microwave-transparent tube.

In certain embodiments, the conversion of H₂S is performed at a temperature in a range of from about 650° C. to about 800° C.

In certain embodiments, a temperature distribution throughout the catalyst bed is substantially uniform.

In certain embodiments, a % conversion of the H₂S is at least 80%.

In certain embodiments, the H₂S treatment is a continuous flow operation.

In certain embodiments, the catalyst bed includes a metal-based catalyst. In certain embodiments, the catalyst bed includes a catalyst and a catalyst support. In certain embodiments, the catalyst support is alumina or a magnesium-based catalyst support.

In certain embodiments, the TWR comprises a resonant tube surrounding a section of the microwave-transparent tube, wherein the microwave source provides microwave radiation to the resonant tube, and the microwave radiation creates a traveling microwave field in the resonant tube.

### BRIEF DESCRIPTION OF THE FIGURES

FIG. 1A is a front view of a diagram of an example TWR.

FIG. 1B is a side view of a diagram of an example TWR.

FIG. 1C is a front view of a diagram of an example TWR.

FIG. 2 is a flowchart of an example method for hydrogen sulfide treatment.

### DETAILED DESCRIPTION

Unless otherwise defined, all technical and scientific terms used in this document have the same meaning as commonly understood by one of ordinary skill in the art to which the present application belongs.

As used in this disclosure, the term “Microwave-Assisted Catalysis (MAC)” refers to a type of catalytic reaction wherein the catalyst is activated by microwave radiation. For example, a heterogeneous catalytic reaction wherein the solid catalyst is activated by microwave radiation.

As used herein, the term “traveling wave reactor (TWR)” refers to a type of microwave reactor that does not rely on standing waves and utilizes traveling microwave fields.

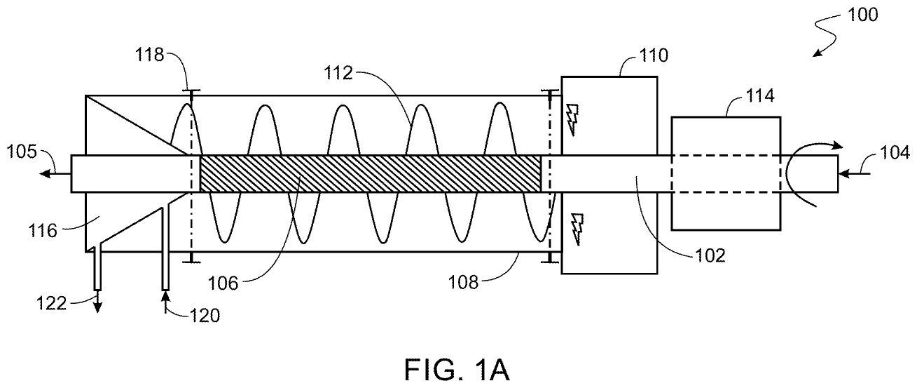

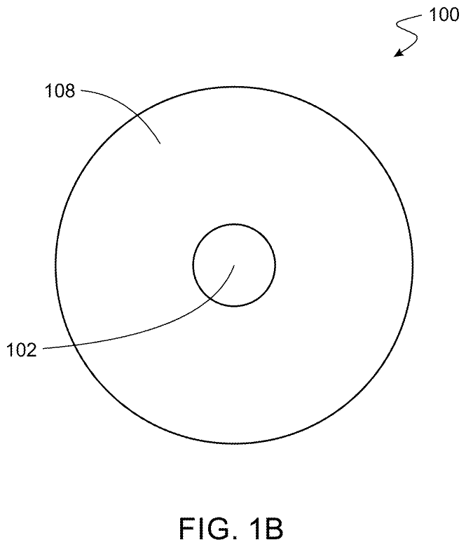

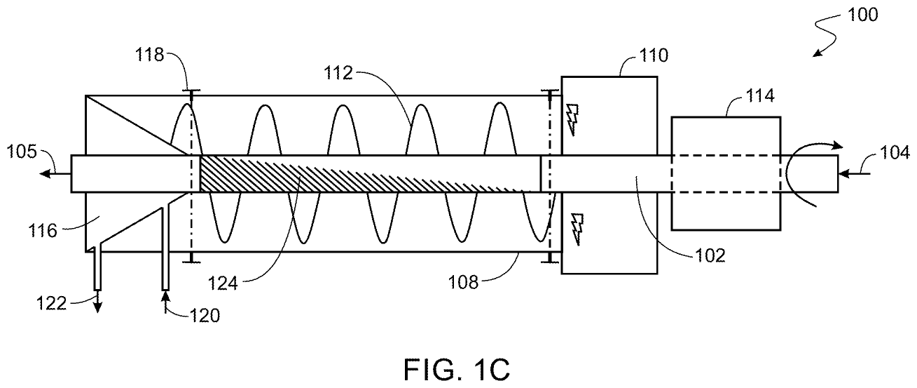

Provided herein is a TWR for use in MAC. FIG. 1A depicts an example TWR 100. The TWR 100 includes an inner microwave-transparent tube 102 having an inlet 104 and an outlet 105. A feed gas can flow in through the inlet 104 and enter the microwave-transparent tube 102. A section of the microwave-transparent tube 102 includes a catalyst bed 106. The section of the microwave-transparent tube having the catalyst bed 106 is surrounded by an outer resonant tube 108. A microwave source 110 provides microwave radiation, microwaves 112, to the resonant tube 108. The microwave radiation provided by the microwave source 110 creates a traveling microwave field in the resonant tube 108. The microwaves 112 emitted from the microwave source 110 activate the catalyst, inducing the catalytic reaction. A tube rotator 114 rotates the microwave-transparent tube 102 to ensure uniform distribution of temperature. In certain embodiments, a microwave absorber 116 is installed at the end of the resonant tube to absorb remnant microwaves. The microwave absorber may include a microwave absorber inlet 120 and a microwave absorber outlet 122, for example, to cycle water. Flanges 118 separate the microwave source 110, resonant tube 108, and microwave absorber 116 into three sections. This can offer more flexibility for scaling up the reaction.

FIG. 1B shows a side view of the TWR 100 having an inner microwave-transparent tube 102 and outer resonant tube 108. The resonant tube 108 surrounds a portion of the microwave-transparent tube 102.

The inner microwave-transparent tube 102 may be composed of any suitable material that is transparent to microwaves. For example, the microwave-transparent tube 102 is a quartz tube.

TWRs, such as TWR 100, have several advantages over other technologies. Unlike TWRs, single mode and multi-mode reactors have an applicator that tunes the microwave frequency to generate standing waves in a resonant cavity. Due to the fixed size of the applicator, these types of microwave reactors have a limited range of operational frequencies and sizes. Further, while standing waves in such resonant cavities are useful for increasing energy transfer, they also cause non-uniform heating at different spots on the catalyst. For example, non-uniform hotspots can be generated due to different dielectric constants of a catalyst and a catalyst support. In this way, materials susceptible to microwaves are directly heated by the microwave radiation, while the materials incapable of absorbing microwaves are heated by conduction from the directly heated materials, and thus, after a time delay. The non-uniform heating issue can affect catalyst stability.

The TWR 100 has a number of advantages over other MAC reactors, including the ability to operate at a large range of frequencies, scalability of the reactor, a modular design, and more uniform heating. Additionally, in a TWR 100 the reaction occurs along the tube's length, enabling more efficient utilization of the microwave energy. The design of the TWR 100 allows for scaling up of reactions. Further, the design of the TWR 100 allows for a continuous flow operation instead of a cavity-based design where scale up is much more difficult and production is performed in batches.

In certain embodiments, the microwave source 110, such as a magnetron, is attached to an end of the resonant tube 108. For example, the microwave source 110 is attached to an end of the resonant tube 108 closest to the inlet 104. The microwave source 110 provides microwaves 112 to the resonant tube 108 to create a traveling microwave field in the resonant tube 108.

The TWRs disclosed herein have proper impedance matching between the inner microwave-transparent tube 102 and the outer resonant tube 108 to avoid generating standing waves. For example, the TWR may have an optimal reactor size for the operational microwave frequency represented by Equation 1:

$${f}_{c} = \frac{c}{( {r}_{0} + {r}_{i} ) π \sqrt{{ε}_{r}}} \qquad ( Equation 1 )$$

wherein f_{c} is the cutoff frequency, c is the speed of light, εᵣ=1 for the relative permittivity of air medium, and r₀, rᵢ are the radii of the inner microwave-transparent tube 102 and outer resonant tube 108. For lab applications having a standard frequency of 2.45 GHZ, the sum of r₀+rᵢ may be lower than 38.94 mm. For industrial applications having a standard frequency of 915 MHz, the sum of r₀+rᵢ may be lower than 104.29 mm. Other frequencies may be used with a decrease in microwave absorption.

In certain embodiments, the microwaves 112 are at a frequency in a range of from 500 MHz to 3000 MHz, such as from 750 MHz to 2500 MHz, from 800 to 1000 MHz, or from 2200 to 2600 MHz. For example, in a lab scale implementation of the TWR 100, the microwaves 112 may have a frequency of about 2450 MHz. In an industrial scale reactor, the microwaves 112 may have a frequency of about 915 MHz.

In certain embodiments, a tube rotator 114 is attached to the microwave-transparent tube 102. The tube rotator 114 is operable to rotate the microwave-transparent tube 102 about a longitudinal axis, for example, along the flow path from the inlet 104 to the outlet 105, as shown in FIG. 1.

The microwave absorber 116 includes a material suitable to absorb remnant microwaves. As used herein, “remnant microwaves” refer to microwaves that were not absorbed by the catalyst in the microwave-transparent tube 102 and have reached the end of the resonant tube 108. For example, the microwave absorber 116 may cycle water through the microwave absorber 116 utilizing the microwave absorber inlet 120 and the microwave absorber outlet 122, which absorbs any remaining microwaves.

In certain embodiments, the TWR 100 comprises additional components or extensions. The design of the TWR 100 disclosed herein is modular and supports installation of multiple extensions to meet production capacity. For example, the TWR 100 may include more than one microwave-transparent tube, more than one resonant tube, and more than one microwave source.

A TWR may have a waveguide structure that is rectangular, circular, or coaxial. In certain embodiments, the TWR 100 has a circular waveguide structure. Coaxial waveguide structures are formed by an inner and an outer conductor, and have electric field lines that run radially while magnetic field lines run in circles around the inner conductor. In certain embodiments, the TWR 100 has a coaxial waveguide structure. In certain embodiments, the TWR has a coaxial waveguide structure. In certain embodiments, the TWR does not have a coaxial waveguide structure.

In certain embodiments, the catalyst bed 106 is packed uniformly in the inner microwave-transparent tube, as depicted in FIG. 1A. In certain embodiments, the catalyst bed is packed in a pattern such that the amount of catalyst is gradually increased in the microwave-transparent tube 102 from a first end of the microwave-transparent tube to an opposite end of the microwave-transparent tube. FIG. 1C depicts an example TWR 100 having a catalyst bed 124 where the amount of catalyst is gradually increased within the microwave-transparent tube 102. This packing pattern can be advantageous to prevent the generation of standing waves.

The catalyst bed 106 or 124 can include any suitable catalyst that is capable of absorbing microwaves, for example, is microwave active. The portion of the catalyst bed 106 or 124 that includes the catalyst may be referred to as the active phase. In certain embodiments, the catalyst bed includes a metal-based catalyst, such as, a metal sulfide, an alloy, a metal oxide, or a pure metal. For example, the metal-based catalyst may be a transition-metal based catalyst, for example, including iron, nickel, molybdenum, copper, cobalt, vanadium, or combinations thereof. In other examples, the metal-based catalyst may include molybdenum sulfide, iron sulfide, silver-bismuth alloy, vanadium oxide, iron oxide, or molybdenum, among others.

In certain embodiments, the catalyst bed 106 or 124 further comprises a catalyst support. For example, the catalyst support may be alumina (Al₂O₃) or a magnesium-based catalyst support. In some examples, the catalyst bed includes MoS₂ embedded in an Al₂O₃ catalyst support.

In certain embodiments, the catalyst bed 106 or 124 is a fixed catalyst bed. For example, a stationary catalyst bed with solid catalyst particles in the form of beads, spheres, granules, or cylinders wherein a gas can flow over the particles. For example, the catalyst bed 106 or 124 may have a packed-bed configuration wherein the microwave-transparent tube is packed with solid catalyst particles, wherein a gas can flow through the particles.

The microwave-transparent tube 102 has a suitable size to support the scale of the MAC reaction to be performed. For example, a diameter of the microwave-transparent tube 102 may be in a range of from 27 mm to 35 mm. Further, a length of the microwave-transparent tube 102 may be from 300 mm to 800 mm. The diameter of the outer resonant tube 108 may be in a range from 39 mm to 47 mm.

The amount of catalyst bed 106 or 124 present in the microwave-transparent tube 102 can be any suitable amount to carry out the MAC reaction. In certain embodiments, the catalyst bed can have a volume ranging from 0.17 L to 0.77 L

In certain embodiments, a temperature distribution throughout the catalyst bed is substantially uniform. The tube rotator 114 rotates the microwave-transparent tube to allow for the uniform distribution of temperature. For example, a highest temperature in the catalyst bed is within about 20% of a lowest temperature in the catalyst bed. In some examples, a highest temperature in the catalyst bed is within about 25%, about 20%, about 15%, about 10%, about 5%, about 2%, or about 1% of a lowest temperature in the catalyst bed. In some examples, a highest temperature in the catalyst bed is within about 150° C., about 100° C., about 50° C., about 30° C., about 20° C., about 10° ° C., about 5° C., or about 1° ° C. of a lowest temperature in the catalyst bed.

In certain embodiments, the TWR 100 is used to treat compounds, such as oil or gas, to decrease or remove hydrogen sulfide contamination. Using the TWR 100 allows the hydrogen sulfide to be converted into hydrogen and elemental sulfur, both of which are useful commercial products.

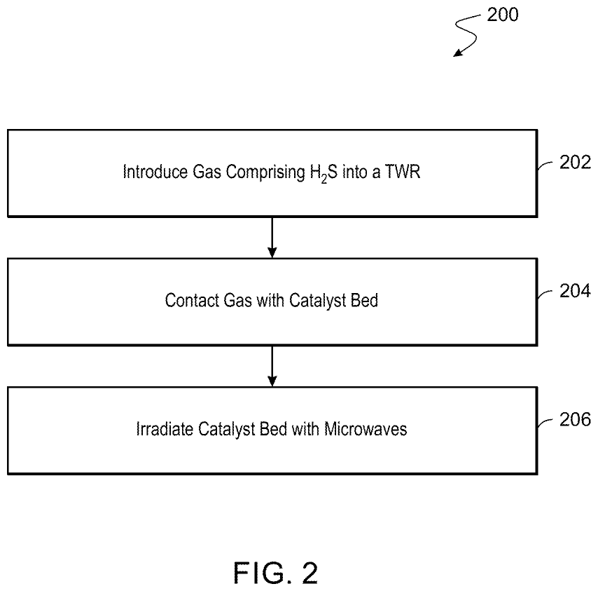

FIG. 2 is a flow chart of an example method 200 for treating hydrogen sulfide. The method begins at block 202, wherein a gas comprising H₂S is introduced into a TWR. The TWR comprises a microwave source and a microwave-transparent tube comprising a catalyst bed, for example, as described with respect to FIG. 1. For example, the gas is introduced into an inlet of a microwave-transparent tube within the TWR that contains the catalyst bed. The TWR can be a TWR disclosed herein. In certain embodiments, the TWR is the example TWR 100 shown in FIGS. 1A and 1B. Block 204 includes contacting the gas with the catalyst bed of the TWR. In certain embodiments, the contacting the gas with the catalyst bed is carried out by flowing the gas over the catalyst bed. Block 206 includes irradiating the catalyst bed with microwaves emitted by the microwave source of the TWR, thereby activating a conversion of H₂S. In certain embodiments, the irradiating activates a catalytic conversion of H₂S to hydrogen gas and elemental sulfur. In certain embodiments, the hydrogen gas flows out of an outlet 105 of the microwave-transparent tube.

The conversion of H₂S is a heterogeneous reaction wherein the gas comprising H₂S reacts with a solid catalyst. When the catalyst bed is irradiated with microwaves, the catalyst bed absorbs microwave radiation generated by the microwave source. The absorption of microwaves activates the catalyst in the catalyst bed. In certain embodiments, the activation of the catalyst by absorption of microwaves induces a temperature increase of the catalyst bed. Without wishing to be bound by theory, the microwave irradiation can cause friction in the molecules of the catalyst inducing heat directly from within the catalyst bed. This method of catalyst activation has advantages over conventional heating. In conventional heating, the whole system is heated and heat is transferred from the environment to the gas and catalyst, costing energy. Microwave activation of a catalyst saves energy and increases reaction efficiency by selectively heating the catalyst, preventing H₂ and S recombination as they are not activated.

In certain embodiments, the method further comprises rotating the microwave-transparent tube. The microwave-transparent tube can be rotated during the H₂S conversion to achieve a substantially uniform distribution of temperature throughout the catalyst bed. For example, a highest temperature in the catalyst bed is within about 25% of a lowest temperature in the catalyst bed. In some examples, a highest temperature in the catalyst bed is within about 20%, about 15%, about 10%, about 5%, about 2%, or about 1% of a lowest temperature in the catalyst bed. In some examples, a highest temperature in the catalyst bed is within about 150° C., about 100° C., about 50° C., about 30° C., about 20° C., about 10° C., about 5° C., or about 1° C. of a lowest temperature in the catalyst bed.

The conversion of H₂S is performed at a temperature and a pressure appropriate for the catalyst to decompose H₂S. In certain embodiments, the conversion of H₂S is performed at a temperature of less than about 1000° C., such as less than about 900° C., less than about 850° C., or less than about 800° C. In certain embodiments, the conversion of H₂S is performed at a temperature range of from about 400° C. to about 1000° C., such as from about 500° ° C. to about 1000° C., from about 550° ° C. to about 950° C., from about 600° C. to about 900° C., or from about 650° ° C. to about 800° C.

In certain embodiments, a conversion % of the H₂S is at least 70%, at least 75%, at least 80%, at least 85%, at least 90%, or at least 95%. The conversion % of the H₂S is measured using gas sensors to monitor input and output gases.

In certain embodiments, the conversion of H₂S is performed in a continuous flow operation. For example, the gas comprising H₂S is continuously fed into the TWR 100 and continuous streams of hydrogen and sulfur are produced.

In certain embodiments, the conversion of H₂S is a single step reaction. In the method disclosed herein, no SO₂ intermediate is formed. Rather, the H₂S can be directly converted to hydrogen gas and elemental sulfur without intermediate steps.

The methods provided herein allow for efficient splitting of H₂S, minimization of energy consumption, maximization of H₂S conversion, and sustainable H₂S treatment. The methods disclosed herein can allow for the generation of hydrogen gas, low operational temperatures, high reaction efficiency, avoidance of H₂ and S recombination, and high conversion % of H₂S.

Applications of the methods disclosed herein include a hydrocarbon refining process to remove hydrogen sulfide impurities from raw hydrocarbons such as gaseous hydrocarbons. For example, hydrogen sulfide impurities are removed before the hydrocarbons are transformed into various products. In some examples, the gas comprising H₂S may be natural gas, or a hydrocarbon stream from a gas refinery.

The H₂ generated by the method disclosed herein can be used for one or more of a variety of purposes. For example, the H₂ generated may be used for fuel, energy production, or oil upgrading.

As used in this disclosure, the term “about” can allow for a degree of variability in a value or range, for example, within 10%, within 5%, or within 1% of a stated value or of a stated limit of a range.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited.

Particular embodiments of the subject matter have been described. Other implementations, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate. For example, in the method disclosed herein, contacting the gas with the catalyst bed, irradiating the catalyst bed with microwaves, and/or rotating the microwave-transparent tube can be performed simultaneously.

What is claimed is:

1. A Traveling Wave Reactor (TWR), comprising:
an inner microwave-transparent tube comprising an inlet and an outlet;
an outer resonant tube surrounding a section of the microwave-transparent tube;
a microwave source operable to provide microwave radiation to the resonant tube, wherein the microwave radiation creates a traveling microwave field in the resonant tube; and
a tube rotator operable to rotate the microwave-transparent tube.

2. The TWR of claim 1, wherein the section of the microwave-transparent tube surrounded by the resonant tube comprises a catalyst bed.

3. The TWR of claim 2, wherein the catalyst bed comprises a metal-based catalyst.

4. The TWR of claim 2, wherein the catalyst bed comprises a catalyst and a catalyst support.

5. The TWR of claim 4, wherein the catalyst support is alumina or a magnesium-based catalyst support.

6. The TWR of claim 1, further comprising a microwave absorber at an end of the resonant tube.

7. The TWR of claim 1, wherein the microwave source does not generate standing waves in the resonant tube.

8. The TWR of claim 1, wherein the microwave source provides microwaves at a frequency in a range of 500 MHz to 3000 MHz.

9. The TWR of claim 1, wherein the tube rotator is operable to rotate the microwave-transparent tube about a longitudinal axis of the microwave-transparent tube.

10. A method for H₂S treatment comprising:
introducing a gas comprising H₂S into a Traveling Wave Reactor (TWR), wherein the TWR comprises a microwave source and a microwave-transparent tube comprising a catalyst bed;
contacting the gas with the catalyst bed; and
irradiating the catalyst bed with microwaves emitted by the microwave source, thereby activating a conversion of H₂S.

11. The method of claim 10, wherein the irradiating activates a catalytic conversion of H₂S to hydrogen gas and elemental sulfur.

12. The method of claim 10, further comprising rotating the microwave-transparent tube.

13. The method of claim 10, wherein the conversion of H₂S is performed at a temperature in a range of from about 650° ° C. to about 800° C.

14. The method of claim 10, wherein a temperature distribution throughout the catalyst bed is substantially uniform.

15. The method of claim 10, wherein a % conversion of the H₂S is at least 80%.

16. The method of claim 10, wherein the H₂S treatment is a continuous flow operation.

17. The method of claim 10, wherein the catalyst bed comprises a metal-based catalyst.

18. The method of claim 10, wherein the catalyst bed comprises a catalyst and a catalyst support.

19. The method of claim 18, wherein the catalyst support is alumina or a magnesium-based catalyst support.

20. The method of claim 10, wherein the TWR comprises a resonant tube surrounding a section of the microwave-transparent tube, wherein the microwave source provides microwave radiation to the resonant tube, and the microwave radiation creates a traveling microwave field in the resonant tube.
